(19) United States
(12) Patent Application Publication
(10) Pub. No.: US 2024/0380837 A1
(43) Pub. Date: Nov. 14, 2024

(54) METHOD AND SYSTEM FOR CALLER-IDENTIFICATION VERIFICATION

(71) Applicant: Doximity, Inc., San Francisco, CA (US)

(72) Inventors: Ricardo Mauricio Garcia Fernandez, Beaverton, OR (US); Aaron Arthur Gray, Birmingham, AL (US); Emmanuel Lagarrigue Lazarte, Bahia Blanca (AR); Andrew Porterfield, Noblesville, IN (US); Elizabeth Doris Marie Stephenson, Port St. Lucie, FL (US)

(21) Appl. No.: 18/314,805

(22) Filed: May 9, 2023

(51) Int. Cl. H04M 3/42; H04W 12/72

(52) U.S. Cl. CPC H04M 3/42042; H04W 12/72

(57) ABSTRACT

A system and method for caller-identification verification. The system includes a memory to store call source data of a call source and one or more processing devices to generate a call using the call source data. The one or more processing devices are further to receive caller-identification data determined in response to receiving the call. The one or more processing devices are further to generate comparison data based on a comparison between the caller-identification data and the call source data. The one or more processing devices are further to generate an alert in response to the comparison data including a mismatch between the caller-identification data and the call source data.

### TECHNICAL FIELD

This disclosure generally relates to phone calls. In particular, this disclosure relates to verifying caller-identification information of phone calls.

### BACKGROUND

Healthcare providers (e.g., doctors, nurses, etc.) may provide various health related services and products to patients. Patients may often visit health care facilities (e.g., hospitals, clinics, etc.) to receive the health-related services and products. For example, a patient may visit a clinic or a hospital for a checkup or to speak with a doctor about a particular medical/health issue. Healthcare providers may also speak with patients on phone calls. Patient phone calls are an important way in which healthcare providers share information, including important diagnostic and treatment information with patients. Phone conversations are similarly used for other business transactions such as, for example, sales, shipping, customer support, and other business services. The exchange of information over phone calls is one of the most important aspects of modern commerce.

### BRIEF DESCRIPTION OF THE DRAWINGS

Embodiments and implementations of the present disclosure will be understood more fully from the detailed description given below and from the accompanying drawings of various aspects and implementations of the disclosure, which, however, should not be taken to limit the disclosure to the specific embodiments or implementations, but are for explanation and understanding only.

FIG. 1 is a diagram illustrating an example network architecture in accordance with one or more embodiments of the disclosure;

FIG. 2 is a block diagram of a caller-ID verification system in accordance with one or more embodiments of the disclosure;

FIG. 3 is a network diagram of an example mobile communications network in accordance with one or more embodiments of the disclosure;

FIG. 4 is an illustration of a database in accordance with one or more embodiments of the disclosure;

FIG. 5 is a flow diagram of an example method in accordance with one or more embodiments of the disclosure; and

FIG. 6 is a block diagram of an example computing device that may perform one or more of the operations described in accordance with one or more embodiments of the disclosure.

### DETAILED DESCRIPTION

As described above, many doctors and other professionals have a need to speak with clients, patients, and others receiving services. Unfortunately for the doctors attempting to contact their patients, the general public is less likely to accept a call from a number they do not recognize. A caller, such as a physician, may call a recipient, such as a patient, to communicate information, e.g., to provide health-related services. The physician may place the call from a personal mobile device, however, the physician may prefer that the patient see the phone number of the incoming call as that of the healthcare facility whom the physician represents for that health-related service, rather than from the personal mobile device. The physician may therefore place the call through a software application running on the personal mobile device, which substitutes a phone number of the healthcare facility as the caller identifier delivered with the call. As described below, such legitimate phone number substitution may be used to cause the patient to see the incoming call as coming from the healthcare facility, even when the call is placed from the personal mobile device.

Thus, there is a need for efficiently verifying what caller-ID data is distributed to patients when they receive the calls. As described herein, this verification may occur before the doctor or other professional actually makes a call. Many doctors and other healthcare professionals and businesses have a need to provide specific caller-ID data for their calls to patients. For example, a doctor calling from an office or a hospital may wish to display their name (e.g., “Dr. Smith”) as the caller-ID data displayed to the recipient of the call. Although the present disclosure is described with reference to healthcare provider calls and services, the present disclosure should not be interpreted as being limited in any way by this description. For example, the subject matter of the present disclosure can be utilized in any field where a user may wish to customize the caller-ID data displayed to the recipient of a call and to verify the caller-ID data received by the user.

The method, system, and non-transitory computer readable storage medium of the disclosure describes an example implementation for verifying the caller-ID data of the calls with the specialized caller-ID data.

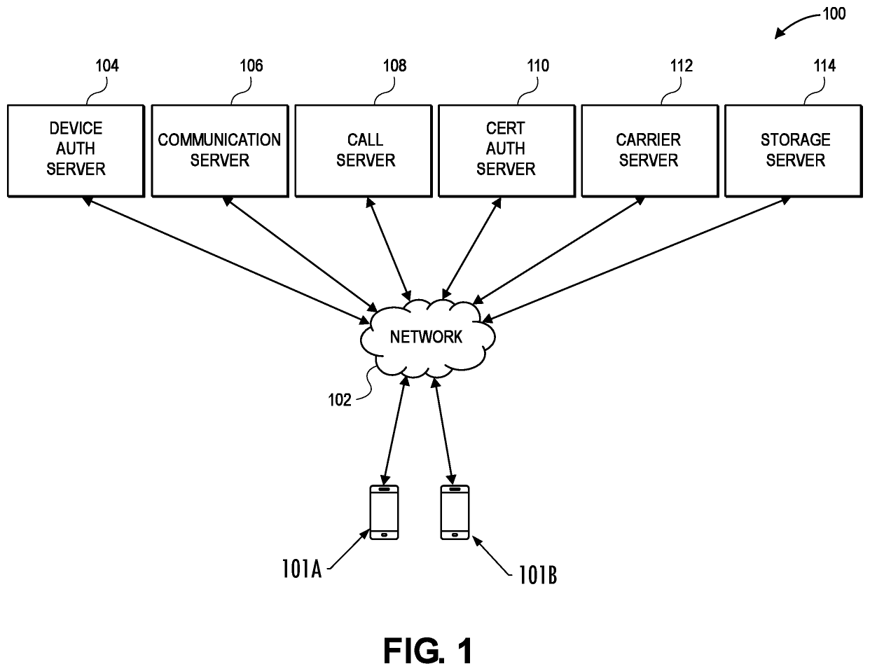

FIG. 1 is a diagram illustrating an example network architecture, in accordance with one or more embodiments of the disclosure. A network architecture 100 includes a network 102 interconnecting one or more computing devices 101, e.g., mobile device (s), with one or more other system components, including a device authorization server 104, a communication server 106, a call server 108, a certification authority server 110, a carrier server 112, and/or a storage server 114. More particularly, the system components can be in data communication with each other through the network 102.

Examples of computing devices 101 may include, but are not limited to, a mobile device, e.g., a smartphone, a tablet computer, or a laptop computer, or a desktop computer, etc. The mobile devices 101 can be owned by a single entity. The mobile devices 101 may be grouped into two or more groups based on integrated circuits installed in and/or contained by the mobile devices 101. More particularly, each mobile device 101 can contain an integrated circuit, such as a Subscriber Identification Module (SIM) card, associated with a mobile carrier, phone settings, and/or mobile contract types. By way of example, the network can include a first mobile device 101A being associated with a first mobile carrier and a second mobile device 101B associated with a second mobile carrier. Accordingly, the mobile devices 101 can be grouped by respective mobile carriers, phone settings, and contract types such that call handling by the mobile devices 101 of the system can provide insight into how each of the mobile devices 101 configurations influence handling of received calls.

The mobile devices 101 of the system can simulate computing devices owned by other users, such as patients, who use services and/or products provided by one or more service providers, such as healthcare providers. More particularly, such users may use a computing device to communicate with one or more service providers, and in the event that such computing devices have SIM cards associated with the same mobile carriers, phone settings, and contract types as the mobile devices 101 in the system, the treatment of calls from the service providers can be assumed to be the same. The mobile devices 101 can be used as a testing system for testing how actual caller-ID data would be displayed to recipients who are actually called by the doctor or other professional making a call.

Healthcare providers may be people who provide health related services and/or products to the user. Examples of healthcare providers may include, but are not limited to, doctors, pharmacists, dentists, nurses, therapists, psychologists, technicians, surgeons, etc. Each healthcare provider may use a computing device (e.g., smartphone, tablet computer, etc.) to communicate with one or more of the users of the service providers. Communications between the healthcare provider and the user may be one-directional communications. For example, the healthcare provider can initiate a call to a user such that a computing device of the user receives the call. The call may be made using a substituted phone number, as described above. If the user calls this number back, they may be connected to, e.g., a facility having the phone number that was substituted, rather than the computer device that initiated the call. Accordingly, by simulating the call handling performed by similar patient mobile devices, the mobile devices 101 of the system can simulate call handling of such substituted numbers. For example, the mobile devices 101 of the system can be used to determine the actual caller-ID data displayed on a recipient's device when a call is made from the doctor's phone.

The other components of the system can operate interactively to place calls to the mobile devices 101, and to monitor how such calls are handled by the mobile devices 101. The individual system components are described next.

A device authorization server 104 can provide authorization for other system components to interact. For example, the device authorization server 104 can perform a device authorization handshake with one or more of the mobile devices 101, as described below, to grant permission to the mobile devices 101 to make requests of another system component, such as a communication server 106.

In an embodiment, the communication server 106 may connect with one or more of the networked mobile devices 101 to facilitate call requests that will initiate phone calls to the mobile devices 101. For example, a user phone (not shown in FIG. 1) that is used by the doctor or other professional, may include or operate one or more software applications to cause a call to be placed from the communication server 106 to the mobile device 101. The user of the software application can create a profile on the application that indicates what caller-ID information (i.e., caller-ID information of the hospital or office) is to be displayed to a recipient of the call. In practice, the recipient of the call would be a patient or other person. In the verification system described herein, the recipient is the mobile device 101, which has a similarly operating software application thereon. The software application running on the mobile device 101 can cause the call to be answered and terminated, and can log data from the call that may be used to identify spam flagging of the call. The communication server 106 can pass along information about the call to the call server 108. For example, the communication server can cause a call to be initiated using call source data (e.g., phone numbers defined in profiles set on the application running on the doctor's phone) and pass along that information, to the call server 108, which then creates a call to a mobile device, such as one of the mobile device 101 or any other mobile device. In the context of the present disclosure, for validating the caller-ID information displayed to the recipient of the call, the mobile devices 101 in FIG. 1 are used, which as described above, are testing mobile devices used to receive test calls.

The call server 108 can initiate the call to a carrier server 112, which will connect the phone call to the mobile devices 101. The call server 108 can create and send a request message that initiates the call using a signaling protocol, e.g., the Session Initiation Protocol. The call server 108 can make the call request using the information passed along by the communication server 106. The call server 108 may be referred to as an originating service provider.

The certification authority server 110 can confirm verification and/or verify phone numbers as being associated with known entities, such as healthcare facilities. The carrier server 112 can complete the call to the mobile device 101. The call may be communicated through additional, intermediate servers between the call server 108 and the carrier server 112 (not shown). The carrier server 112 can be maintained by a same or different entity than that which maintains the call server 108. For example, the carrier server 112 and/or the call server 108 may be maintained by an entity that provides communication tools for making and receiving phone calls, sending and receiving text messages, and performing other communication functions. The communication functions can be performed through web service application programming interfaces, for example. In an embodiment, the carrier server 112 is maintained by a mobile carrier. The mobile carrier can be a carrier associated with the integrated circuit installed in the mobile device 101 receiving the phone call. The carrier server 112 may be referred to as a terminating service provider. The terminating service provider can determine whether and how to send the phone call to the recipient device.

The storage server 114 can be a cloud server providing storage accessed on demand by other system components. For example, the storage server 114 can store logged data received from the mobile devices 101 after completion of the phone call. The logged data may indicate caller-ID data, including historical logs of caller-ID data for calls received by the mobile devices 101. For example, the logged data can be used to track how caller-ID data has changed for received calls over time for each of the mobile devices 101.

Processes described below may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, the processes may be performed by the various components of the system, including the servers and mobile devices 101 described above.

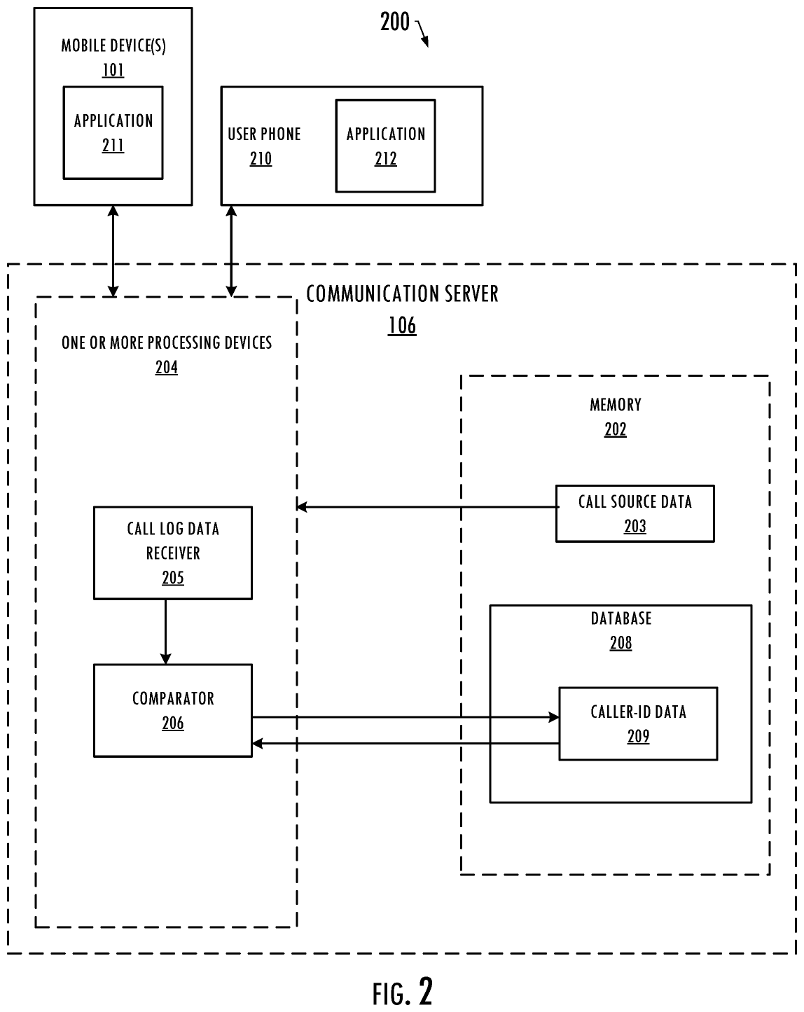

FIG. 2 illustrates a block diagram of an example system 200 for caller-ID verification in accordance with one or more embodiments of the present disclosure. In some embodiments, the system comprises a server, such as communication server 106 shown in FIG. 1. The system includes a memory 202 storing call source data 203 (e.g., application profile selections described herein) of a call source (e.g., user phone 210, such as that of a doctor initiating a call to a patient). The system further includes one or more processing devices 204 to access the memory and execute instructions stored thereon. The communication server is used to generate one or more calls using the call source data 203 of the call source. In some embodiments, the call source data includes at least a phone number associated with a profile selection on an application 212 operating on the user phone 210 of the doctor. In some embodiments, the communication server is a server in a cloud network to generate a call from an application programming interface (API). The doctor or user selects a profile on the application 212 and this profile selection substitutes the phone number belonging to the user phone 210 with a doctor's office or hospital or other venue as defined in the profile selection. The doctor or user may then make a call through the application 212 to any number they wish. The call is then initiated by the communication server 106, which inserts the call source data 203 (i.e., determined from the profile selection made by the user or doctor on the application) into memory, and then the call is made from the communication server 106 to one or more of the mobile devices 101, which also have an application 211 operating thereon. As described further below, validation of that caller-ID data can then be performed.

In some embodiments, call source data establishes expected caller-ID data of the call source. For example, when the doctor (or other user) initiates a call, the doctor may input or select, based on a profile, the expected caller-ID data that they wish to show to the user. The profile can include one or more offices, hospitals, etc. associated with the doctor, where the caller-ID data displayed to the recipient of the call will be the caller-ID data of that office or hospital based on the data included in the profile. In such an example, specific caller-ID information may be expected to be displayed to the recipient based on the caller-ID information of the organization associated with the doctor. The expected caller-ID data is the caller-ID information that the doctor expects to be displayed to recipients they call based on the profile in the application 212 that they select.

In some embodiments, the one or more processing devices 204 are to receive or access the call source data 203, which can take various forms, from the memory 202 of the communication server 106. The communication server 106 then generates one or more calls, each call to one or more mobile devices 101, and some of the mobile devices may be associated with a different phone or mobile carrier, such as the mobile devices described in FIG. 1 above. In other words, the communication server may generate several calls, each call generated using the call source data, and each call being received by a different mobile device which may be associated with a different carrier than the other mobile devices. The one or more mobile devices 101 may include a first mobile device (such as first mobile device 101A in FIG. 1) associated with a first mobile carrier and a second mobile device (such as second mobile device 101B in FIG. 1) associated with a second mobile carrier. The mobile device carriers associated with each call will receive one of the calls generated by the communication server, and the respective mobile carriers will determine the caller-ID data to be displayed on each of the mobile devices based on the call source data 203.

As stated above, the mobile devices 101 also have applications 211 operating thereon. These applications are in communication with the communication server 106, just as the application 212 operating on the user's phone 210 is in communication with the communication server. When a mobile device 101 receives the call initiated by the communication server, the application 211 operating on the mobile device 101 captures caller-ID data associated with the received call. The caller-ID data may include the phone number of the office or hospital associated with the call source data 203, descriptive text (e.g., a name or phrase identifying the office or hospital or any other venue) showing the source of the call, and any other suitable data that can identify the source of the call received by the mobile device 101. The application 211 of the mobile device 101 then sends the received caller-ID data to the communication server 106.

In some embodiments, the one or more processing devices include a call log data receiver 205 which receives call logs including caller-ID data determined in response to receiving the call (i.e., at or by the mobile device 101). The caller-ID data may be received by the call log data receiver 205 of the communication server 106 from the application 211 running on the recipient phone, such as mobile devices 101A or 101B shown in FIG. 1.

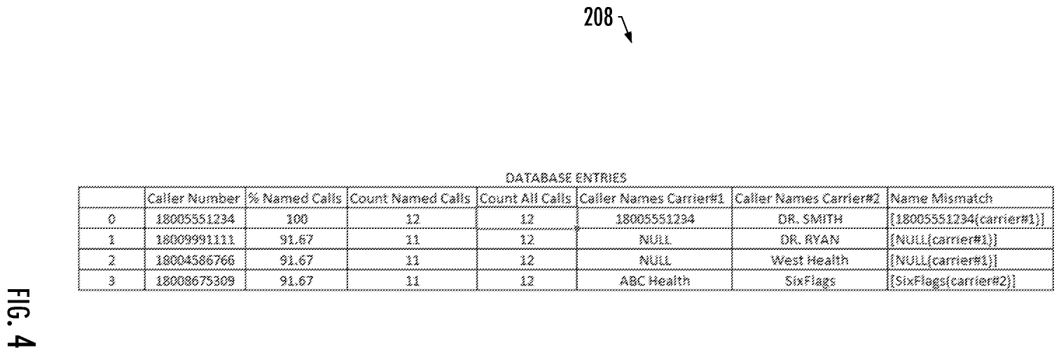

In some embodiments, the memory 202, such as a persistent memory storage device (e.g., a hard drive), includes a database 208 stored thereon. The one or more processing devices 204 is further to populate a corresponding database entry in the database for each of the caller IDs used in calls generated by the communication server 106 to one or more mobile devices 101. An example database entry is illustrated in FIG. 4 below. The one or more processing devices 204 also includes a comparator 206. Once the database is populated with entries, the one or more processing devices is to perform, using the comparator, a comparison between the caller-ID data and the call source data (e.g., the expected caller-ID data based on the profile selected by the user). That is, the one or more processing devices are to perform a comparison of the caller-ID data determined for each mobile phone and/or mobile phone carrier, and the call source data (i.e., the expected caller-ID data).

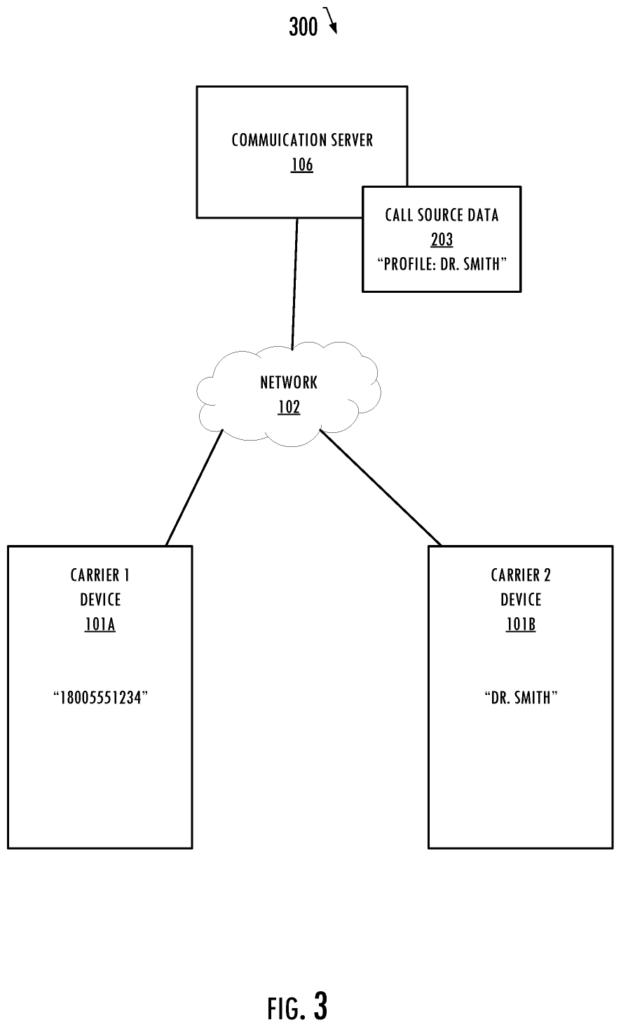

The comparison is performed to determine if there is a mismatch between the caller-ID data and the call source data (i.e., expected caller-ID data). That is, the comparison determines whether the caller-ID data generated by a carrier is the correct caller-ID data to display to a recipient for a given call source data. An example is illustrated in the description with respect to FIG. 3 and FIG. 4. The one or more processing devices 204 are to generate comparison data based on the comparison between each corresponding database entry (e.g., the caller-ID data received for each phone), including caller-ID data determined for each phone carrier, and to the call source data. The comparison data generated can indicate or include whether there is a mismatch between the caller-ID data in the database entry and previously recorded caller-ID data or the expected caller-ID data from the call source data.

In some embodiments, in response to the comparison data including or indicating a mismatch between the caller-ID data and the previously recorded caller-ID data or the call source data, the one or more processing devices 204 is to generate an alert. For example, in some cases, the one or more processing devices is to generate the alert indicating the mismatch and transmit the alert to a user phone 210 informing the user that the caller-identification data does not match the call source data of the call source. The alert can also be sent to any suitable computing device for observation. A computing device could include database 208, a server, video display 610 described below, or any other suitable device for storing, displaying, or processing data. As described above, the caller-ID validation is performed using a test call generated by the communication server using the call source data from the profile selected by the user. The user can be notified of the incorrect caller-ID data before an actual call is made to, for example, a patient.

As discussed above, the one or more processing devices 204 of the communication server 106 are to generate one or several calls (one at a time, but multiple can be made over a period of time), each of the one or several calls to a discrete mobile device. For example, in some embodiments, the one or more processing devices are further to generate a plurality of calls using the call source data for each call. The system 200 includes a plurality of discrete mobile devices, such as mobile devices 101, with each mobile device being associated with one of the major phone carrier networks. For example, as shown in FIG. 3 and described below, there can be a first mobile device such as carrier A device 101A associated with carrier A and a second mobile device such as carrier B device 101B associated with carrier B. Each of the mobile devices are to receive one of the several calls generated by the communication server.

As described above, the one or more processing devices 204 is further to populate a corresponding database entry in the database 208 for each of the caller IDs used to generate a call by the communication server 106 to one of the mobile devices 101. That is, the one or more processing devices is further to populate a corresponding database entry with received caller-ID data for each of the mobile devices that receives one of the plurality of calls generated by the communication server. As described herein, the one or more processing devices are further to compare the corresponding database entries, including the caller-ID data stored in each of the corresponding database entries, with previous call data with the call source data (e.g., the expected caller-ID data) and generate comparison data based on the comparisons.

In some example embodiments, the one or more processing devices are to generate a first call to a first mobile device (e.g., first mobile device 101A from FIG. 1) using the call source data and a second call to a second mobile device (e.g., second mobile device 101B from FIG. 1) using the same call source data. The first mobile device and second mobile devices can be associated with different phone carriers. The one or more processing devices are further to receive caller-ID data determined in response to the first mobile device and the second mobile device receiving the first call and second call respectively. The one or more processing devices then populate the database with caller-ID data received from the applications operating on both the first and second mobile devices and compare the two entries to each other and to the expected caller-ID data from the call source data. The one or more processing devices then generate comparison data including or indicating whether there is a mismatch between the caller-ID data from the two devices or from the expected result based on the carrier of the first caller-ID data or the second caller-ID data and the call source data (i.e., expected caller-ID data). In response to the comparison data including or indicating a mismatch between the first caller-ID data and the call source data or between the second caller-ID data and the call source data or between the first and second caller-ID data, the one or more processing devices are to generate a record of the mismatches for observation and tracking by an interested user, as described above.

FIG. 3 is a network diagram of an example mobile communications network 300 in accordance with one or more embodiments of the disclosure. As shown, the mobile communications network includes the communication server 106 with call source data 203 (e.g., selected profile) indicating the user has selected “DR. SMITH” as the profile in their application and this call source data has been stored in the communication server. The communication server initiates several calls using the call source data and those calls are created by a call server (call server 108 from FIG. 1) and transmitted across the network 102 to carrier 1 device 101A and carrier 2 device 101B. Carrier 1 translates the call source data into caller-ID data “18005551234”. That is, the caller-ID data displayed on the screen of carrier 1 device 101A is “18005551234”. Carrier 2 translates the call source data into caller-ID data “DR. SMITH”. That is, the caller-ID data displayed on the screen of carrier 2 device 101B is “DR. SMITH”. The system 200 described above with respect to FIG. 2 creates or updates a database entry for the caller-ID, one for each received call at the carrier 1 device and the carrier 2 device. These database entries are illustrated in FIG. 4 and described below. Additional examples are given below in FIG. 4. Although only two carriers and two phones are depicted in FIG. 3 and FIG. 4, this should not be construed so as to limit the number of phones or number of carriers. Any number of phones and any number of carriers can be used.

In some embodiments, the call discussed above is a first call received by a first mobile device associated with a first phone carrier, and the one or more processing devices are further to initiate or generate a second call to a second mobile device associated with a second phone carrier using the call source data of the call source; receive second caller-identification data determined in response to receiving the second call; generate comparison data based on a comparison between the second caller-identification data and the call source data; and generate a second alert in response to the comparison data including a mismatch between the second caller-identification data and the call source data. FIG. 4 below illustrates this embodiment.

FIG. 4 is an illustration of a database 208 in accordance with one or more embodiments of the disclosure. The database includes various entries including one database entry for each mobile device with a column for the incoming caller name recorded for each carrier for each call received. In this example, as detailed in FIG. 3 above, several calls have been placed to two different phones, each associated with a different carrier, carrier A and carrier B. The system 200 described above creates a database entry in the database, for calls made from a given phone number. For example, referring to the caller-ID data shown in FIG. 3, the carrier 1 device received caller-ID data of “18005551234” and the system includes that caller-ID data in the database entry for a given phone number. On the other hand, the carrier 2 device received caller-ID data of “DR. SMITH” and the system includes that caller-ID data in the database entry for carrier 2 data displayed for a given phone number. In some embodiments, the comparison is a comparison between exact or related words and/or a comparison between numbers.

As described above, the system 200 is further to perform a comparison of the caller-ID data in each database entry between carriers based on the call source data, or with expected caller-ID data based on the call source data. For example, with respect to carrier 2 device, the system will compare the caller-ID data received (i.e., “DR. SMITH”) with the expected caller-ID data (i.e., “DR. SMITH”) and determine that there is not a mismatch between the received caller-ID data and the expected caller-ID data. As such, the system will have no mismatch to report. The system may also compare the caller-ID data received by multiple carriers, such as carrier 1 (i.e., “18005551234”) and carrier 2 (i.e., “DR. SMITH”) and determine that there is a mismatch between carriers and report the mismatch to an interested user.

On the other hand, in response to the system 200 comparing the carrier 1 device database entry of the received caller-ID data (i.e., “800-555-1234”) to the expected caller-ID data (“DR. SMITH”), the system will determine that there is a mismatch between the expected caller-ID data and the received caller-ID data. As such, the system will send an alert indicating the mismatch to the user of the user device. For example, the alert could be any textual (e.g., email message, SMS, etc.) or non-textual (e.g., log entry, electronic signal, automated phone call, etc.) form of communication alerting the user of the mismatch.

Not all carriers support the application of a caller name, so the absence of the name in cases where it is not expected to be supported is also valid verification that the system 200 is working as expected.

In some implementations, the above procedures for verifying the caller-ID data of the source device may be performed periodically to ensure the caller-ID data does not become incorrect over time. For example, verification of the caller-ID data can be performed daily, weekly, monthly, or any other appropriate frequency. Additionally, as the caller-ID data is verified, the verification results can be logged in a logging system to keep track of the caller-ID data verification results over time. For example, the logging system can be one or more entries in the database 208 shown in FIG. 2.

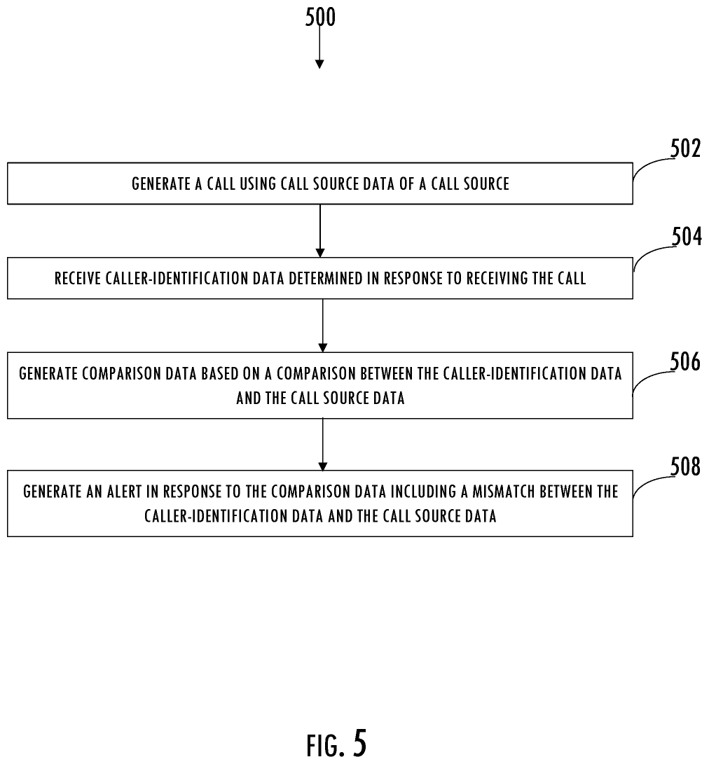

FIG. 5 is a flow diagram of an example method 500 in accordance with one or more embodiments of the disclosure. For example, as shown in first block 502, the method 500 includes generating a call using call source data of a call source. As shown in second block 504, the method includes receiving caller-identification data determined in response to receiving the call. As shown in third block 506, the method includes generating comparison data based on a comparison between the caller-identification data (e.g., from multiple carriers or between the caller-ID data and the call source data) and the call source data. As shown in fourth block 508, the method includes generating an alert in response to the comparison data including a mismatch between the caller-identification data and the call source data.

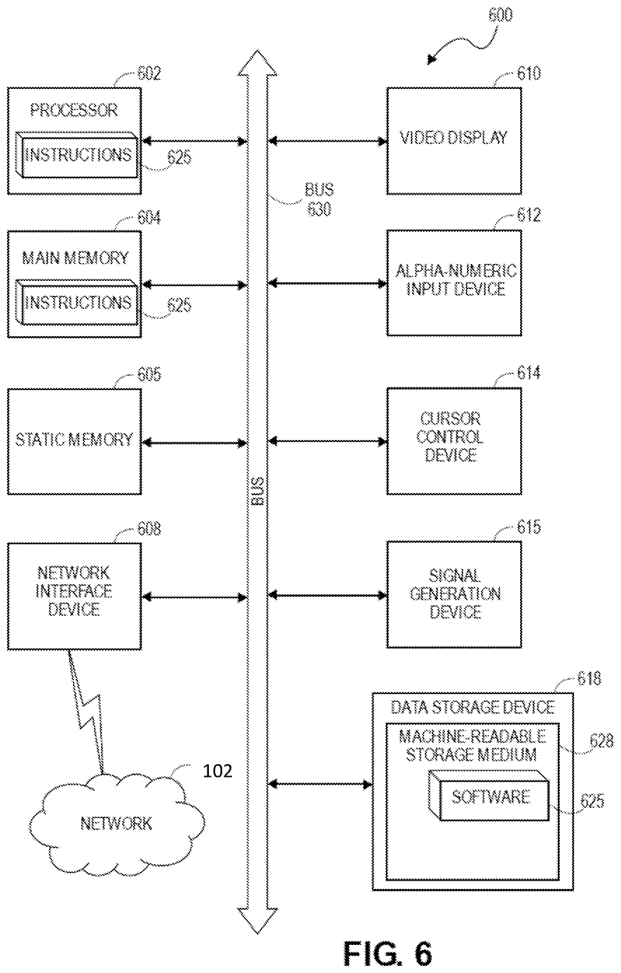

FIG. 6 is a block diagram of an example computing device 600 that may perform one or more of the operations described herein (such as the operations of the one or more processing devices 204 described in FIG. 2), in accordance with some embodiments. More particularly, computing device 600 may be integrated in or separate from any of the servers and/or devices described above to perform any of the described operations. Computing device 600 may be connected to other computing devices in a local area network (LAN), an intranet, an extranet, and/or the Internet. The computing device may operate in the capacity of a server machine in the client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 600 may include one or more processing devices (e.g., a processing device, a general purpose processing device, a PLD, etc.) 602, a main memory 604 (e.g., synchronous dynamic random access memory (DRAM), read-only memory (ROM)), a static memory 605 (e.g., flash memory and a data storage device 618), which may communicate with each other via a bus 630.

The one or more processing devices 602 may be provided by one or more general-purpose processing devices such as a microprocessor, central processing unit, or the like. In an illustrative example, processing device(s) 602 may comprise a complex instruction set computing (CISC) microprocessor, reduced instruction set computing (RISC) microprocessor, very long instruction word (VLIW) microprocessor, or a processing device implementing other instruction sets or processing devices implementing a combination of instruction sets. Processing device(s) 602 may also comprise one or more special-purpose processing devices such as an application specific integrated circuit (ASIC), a field programmable gate array (FPGA), a digital signal processor (DSP), network processor, or the like. The processing device(s) 602 may be configured to execute the operations described herein, in accordance with one or more aspects of the present disclosure, for performing the operations and steps discussed herein.

Computing device 600 may further include a network interface device 608 which may communicate with a network 102. The computing device 600 also may include a video display unit 610 (e.g., a liquid crystal display (LCD) or a cathode ray tube (CRT)), an alphanumeric input device 612 (e.g., a keyboard), a cursor control device 614 (e.g., a mouse) and an acoustic signal generation device 615 (e.g., a speaker). In one embodiment, video display unit 610, alphanumeric input device 612, and cursor control device 614 may be combined into a single component or device (e.g., an LCD touch screen).

Data storage device 618 may include a non-transitory computer-readable storage medium 628 on which may be stored one or more sets of instructions 625 that may include instructions for carrying out the operations described herein, in accordance with one or more aspects of the present disclosure. Instructions 625 may also reside, completely or at least partially, within main memory 604 and/or within processing device(s) 602 during execution thereof by computing device 600, main memory 604 and processing device(s) 602 also constituting computer-readable media. The instructions 625 may further be transmitted or received over a network 620 via network interface device 608.

While computer-readable storage medium 628 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method for caller-identification verification, the method comprising:
generating a call using call source data of a call source;
receiving caller-identification data determined in response to receiving the call;
generating comparison data based on a comparison between the caller-identification data and the call source data; and
generating an alert in response to the comparison data including a mismatch between the caller-identification data and the call source data.

2. The method of claim 1, wherein generating the call includes generating a call by a server using the call source data from the call source, the call source data including call data associated with a user of the call source.

3. The method of claim 1 further comprising generating and receiving a plurality of calls, each of the plurality of calls generated using the call source data, and each of the plurality of calls received at a discrete mobile device, each mobile device being associated with a different phone carrier.

4. The method of claim 3 further comprising populating a corresponding database entry for each caller-identification data used in generation of one of the plurality of calls.

5. The method of claim 4, wherein the comparison data is generated from a comparison between caller-identification data determined for each phone carrier, and to the call source data.

6. The method of claim 1 further comprising transmitting the alert to a computing device indicating that the caller-identification data does not match the call source data of the call source.

7. The method of claim 1, wherein the call is a first call received by a first mobile device associated with a first phone carrier, wherein the caller-identification data is first caller-identification data, and the method further comprises:
generating a second call to a second mobile device associated with a second phone carrier using the call source data of the call source;
receiving second caller-identification data determined in response to receiving the second call;
generating comparison data based on a comparison between the first caller-identification data and the second caller-identification data and to the call source data; and
generating a second alert in response to the comparison data including a mismatch between the first and second caller-identification data or the call source data.

8. A system for caller-identification verification, the system comprising:
a memory storing call source data of a call source; and
one or more processing devices to:
generate a call using the call source data;
receive caller-identification data determined in response to receiving the call;
generate comparison data based on a comparison between the caller-identification data and the call source data; and
generate an alert in response to the comparison data including a mismatch between the caller-identification data the call source data.

9. The system of claim 8, wherein the system includes a server to initiate a call using the call source data from the call source, the call source data including call data associated with a user of the call source.

10. The system of claim 8 wherein the one or more processing devices are further to generate a plurality of calls using the call source data, the system further comprising:
a plurality of discrete mobile devices, each mobile device being associated with a different phone carrier, and each of the mobile devices to receive one of the plurality of calls.

11. The system of claim 10, wherein the one or more processing devices is further to populate a corresponding database entry for each caller-identification data used in generation of one of the plurality of calls.

12. The system of claim 11, wherein the comparison data is generated from a comparison between each corresponding database entry, including caller-identification data determined for each phone carrier, and to the call source data.

13. The system of claim 8, wherein the one or more processing devices is further to transmit the alert to a computing device indicating that the caller-identification data does not match the call source data of the call source.

14. The system of claim 8, wherein the call is a first call received by a first mobile device associated with a first phone carrier, and the one or more processing devices are further to:
generate a second call to a second mobile device associated with a second phone carrier using the call source data of the call source;
receive second caller-identification data determined in response to receiving the second call;
generate comparison data based on a comparison between the second caller-identification data and the call source data; and
generate a second alert in response to the comparison data including a mismatch between the second caller-identification data and the call source data.

15. A non-transitory computer readable storage medium storing instructions executable by one or more processing devices of a system to perform a method for caller-identification verification, the method comprising:
generating a call using call source data of a call source;
receiving caller-identification data determined in response to receiving the call;
generating comparison data based on a comparison between the caller-identification data received and the call source data; and
generating an alert in response to the comparison data including a mismatch between the caller-identification data and the call source data.

16. The non-transitory computer readable storage medium of claim 15, wherein generating the call includes generating a call by a server using the call source data from the call source, the call source data including at least call data associated with a user of the call source.

17. The non-transitory computer readable storage medium of claim 15, receiving a plurality of calls, each of the plurality of the calls generated using the call source data, and each of the plurality of the calls received at a discrete mobile device, each mobile device being associated with a different phone carrier.

18. The non-transitory computer readable storage medium of claim 17 further comprising populating a corresponding database entry for each of the mobile devices that receives one of the plurality of the calls.

19. The non-transitory computer readable storage medium of claim 18, wherein the comparison data is generated from a comparison between each corresponding value in a database entry, including caller-identification data determined for each phone carrier, or the call source data.

20. The non-transitory computer readable storage medium of claim 15, wherein the method further comprises transmitting the alert to a computing device indicating that the caller-identification data does not match the call source data of the call source.
